(19) United States
(12) Patent Application Publication
(10) Pub. No.: US 2013/0173648 A1
(43) Pub. Date: Jul. 4, 2013

(54) Software Application Recognition

(71) Applicants: Xiang Tan, Shanghai (CN); Zheng Ling, Shanghai (CN); Li-Hao Chen, Shanghai (CN)

(72) Inventors: Xiang Tan, Shanghai (CN); Zheng Ling, Shanghai (CN); Li-Hao Chen, Shanghai (CN)

(21) Appl. No.: 13/821,208

(22) PCT Filed: Oct. 29, 2010
(86) PCT No.: PCT/CN10/01720

§ 371 Date: Mar. 6, 2013

(51) Int. Cl. G06F 17/30

(52) U.S. Cl. CPC G06F 17/30283
USPC 707/758

(57) ABSTRACT

A method for recognizing software applications installed on hardware devices includes scanning a hardware device to discover a target software application installed on the hardware device, where the target application includes one or more files; retrieving one or more sample applications for comparison to the target application; determining a resemblance between the target application and each of the one or more sample applications; and identifying the target application based on the resemblance determination.

### BACKGROUND

Business management systems may use automated features to manage hardware devices such as computers and software applications installed and executing on the computers, including on a network of computers. These automated features allow a human user to discover, track, and inventory hardware, software, and network assets that make up an organization's information technology (IT) infrastructure.

### DESCRIPTION OF THE DRAWINGS

The detailed description will refer to the following figures in which like numerals refer to like items, and in which:

FIG. 1 illustrates an example of a computer system in which software recognition is implemented;

FIG. 2 illustrates an example of a software recognition system;

FIG. 3 illustrates a conceptual framework for the software recognition system of FIG. 2;

FIG. 4 illustrates an example algorithm used by the software recognition system of FIG. 2; and

FIG. 5 illustrates an example of a method for software recognition using the software recognition system of FIG. 2.

### DETAILED DESCRIPTION

Organizations with large information technology (IT) infrastructures often employ some type of business service automation system to manage and control their IT assets, including hardware components and the software residing and executing on the hardware components. A typical business services automation system may include a discovery and dependency mapping inventory (DDMI) system that periodically scans hardware components to discover, identify, and inventory software applications. Individual file records are created for each instance of a discovered software application. The software application may include many individual files, and the files may be spread across multiple directories. For example, a word processing application may include a main .exe file and several associated files such as dll files. The .exe file may be contained in a first directory and the .dll files in a second directory. A discovery engine produces a scanning result file (an XML-formatted file, for example) containing file records for each of these individual files in a particular directory. The file records in a scanning result file are submitted to a recognition engine, one file record at a time. Each file record contains feature information such as file name and file size. For each file record, the recognition engine compares the feature information to features of sample files that may be contained in a sample application inventory. When the aggregate feature information from the discovered software application is sufficiently close in value to that of the sample software application, the recognition engine determines that a match exists, and identifies the discovered software application as the same as the matching sample software application.

However, the hardware platform on which the discovered software application is found may contain only the main (e.g., .exe) file, and none of the associated (e.g., .dll) files. Yet the software application matching process might still “declare” a match with a sample software application. In addition, the discovered software application could match more than one version of the sample software application. In this case, a further, complicated elimination process may be required to determine the correct identity of the discovered software application.

For example, in the presence of multiple versions, if at least one version has an install string, then all sample software applications without an install string are discarded. Of the remaining versions, those sample software applications whose language is the recognition engine's configurable preferred language are selected. If this language selection step selects no sample software application versions, then those sample software application versions whose language is neutral language are selected. If there are no neutral language sample software application versions, then those versions whose language is English are selected. If more than one sample software application remains after these language-based elimination steps, all remaining sample software applications could possibly match the discovered software application and the recognition engine then may arbitrarily choose a sample software application as the identity of the discovered software application. Many other criteria may be used to try to identify or recognize the correct version of the discovered software application. In particular, a complex, multi-level analysis may be required, where the analysis includes a file-level recognition process, a directory-level recognition process, and a machine-level recognition process. This multi-level analysis is referred to hereinafter as a DDMI recognition process, algorithm, or method. The complexity and processor-intensive nature of this DDMI recognition algorithm stems in part from the use of many different criteria in order to select a correct version of a software application, making the logic more complicated and sample application index database maintenance more difficult. Another disadvantage is that the DDMI recognition algorithm may declare a match between a discovered software application and a sample software application based on a comparison of the applications' main file, and ignoring the applications' associated files, which may differ because of version changes, resulting in an erroneous identification of the discovered software application.

Rather than the complicated, laborious and sometimes erroneous DDMI recognition process, as described above, of setting criteria and matching to a discovered software application over multiple levels and across multiple directories, a herein disclosed software application identification device, system, and method determines a resemblance between a set of queried or discovered files and sample applications that are stored in a software application index database so as to identify a target software application in a fast, reliable manner.

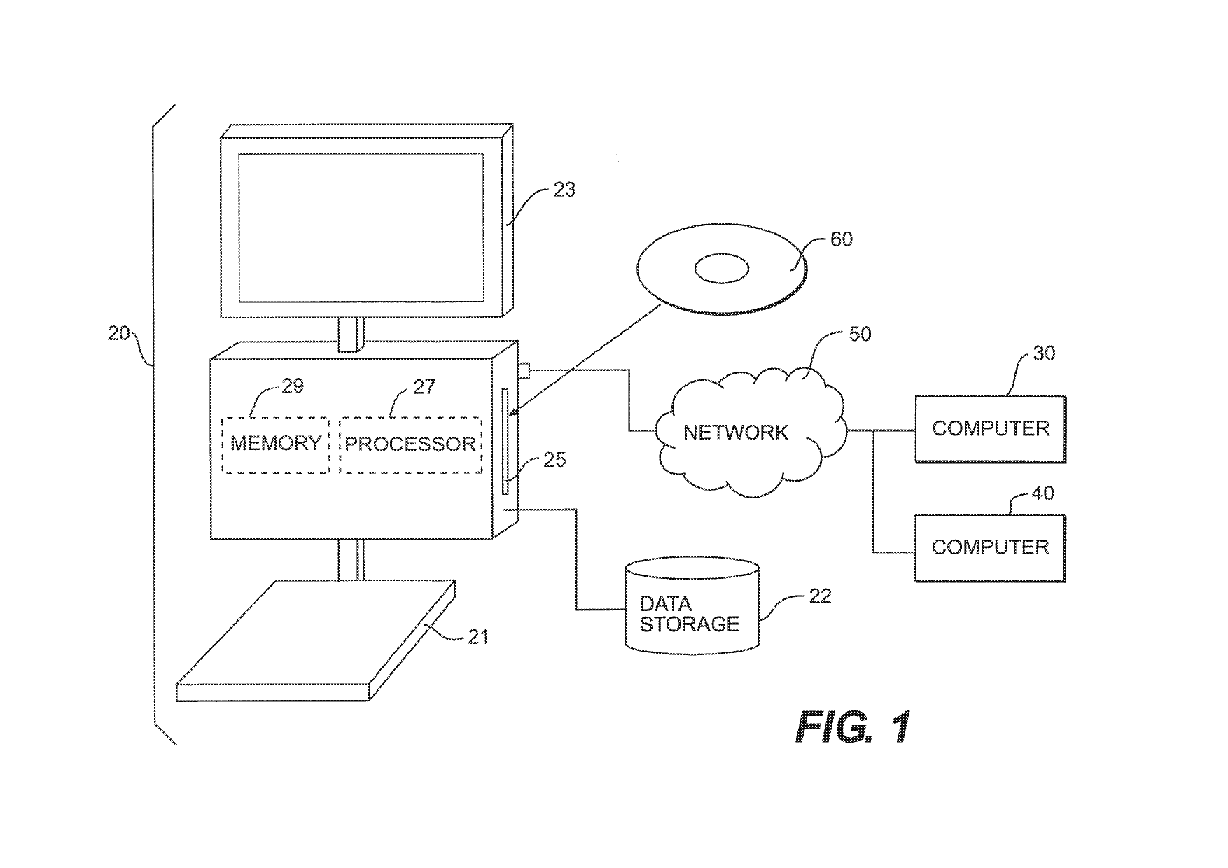

FIG. 1 illustrates an example of computer system in which software application recognition is implemented. In FIG. 1, computer system 10 includes computers 20, 30, 40 coupled by network 50. The network 50 may be a local area network, a wide area network, or a public access network. Computer 20 includes user interface 21, display 23, and media port 25, processor 27 and memory 29. Memory 29 may be a random access memory (RAM), for example. Coupled to computer 20 is data store 22, which may be a read only memory (ROM). Alternately, the data store 22 may be incorporated into the computer 22. Removable computer readable media 60, which, in an example, is an optical disk, contains data, execution files, and installation files that enable software application recognition. Removable computer readable media 60 may be inserted into the media port 25 to transfer the software application data, execution, and installation files to the computer 20, where the data and files may be stored in the data store 22 and copied to the memory 29 for execution of a software application recognition process.

The computer system 10 is shown with three connected computers 20, 30, and 40, although the system 10 may include many more computers. Each of the computers 30 and 40 may include software application recognition features similar to those described above for computer 20, and the software application recognition features may be used by each computer 20, 30, and 40 to manage locally installed software applications. Alternately, the software application recognition features may reside on computer 20 only, and those features may be used to manage software applications on all three computers 20, 30, 40.

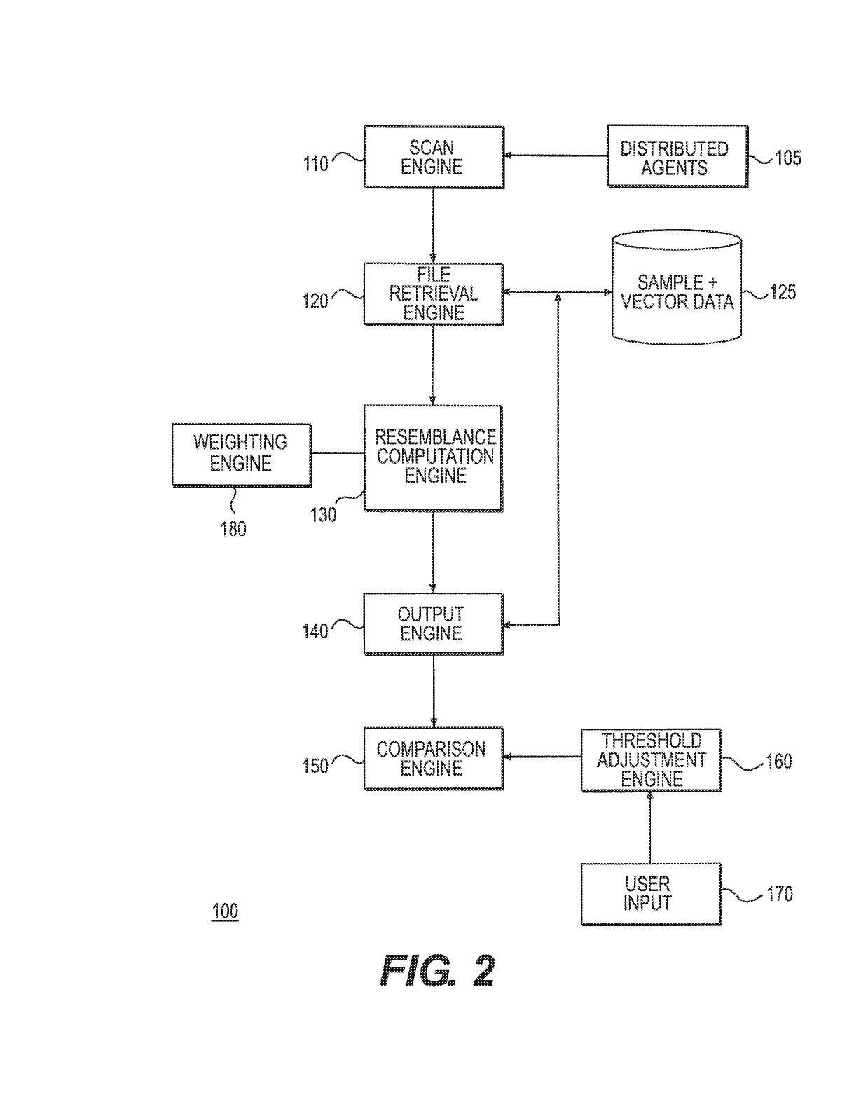

FIG. 2 illustrates an example of a software recognition system. In FIG. 2, software recognition system 100 includes scanning engine 110, the retrieval engine 120, resemblance engine 130, output engine 140, comparison engine 150, and threshold adjustment engine 160. The scanning engine 110, using distributed agents 10, scans the various computers 20, 30, 40 to discover software applications resident thereon, and to determine the attributes of each such discovered software application. The attributes may be included in header data included within the software application, for example. The discovered applications then are passed to file retrieval engine 120, which uses the attribute data identified by the scanning engine 110 to select appropriate sample software application files from sample application and vector database 125. The selection may be based on a simple filtering operation. For example, if a scanned software application is a word processor, the file retrieval engine 120 may select all word processor applications from the database 125. The selected software application files then are sent to resemblance engine 130, which computes a resemblance value between each selected sample software application and each discovered software application. The computed resemblance value may be based on any number of identified attributes, including file name, vendor, size, and language. Furthermore, weighting engine 180 may be used to apply a user-selected or vendor designated weight to each of the attributes used in computing the resemblance value. In one default situation, each identified attribute is assigned an equal weight; in effect, the attributes are not weighted. In another default situation, a vendor assigns a weight based on the importance of the file or attribute. For example, a .exe file would be assigned a weight of 0.5. Thus, different weights may be assigned to the attributes, although some attributes still may have the same weights. The different weights may be assigned by a system administrator, or may be assigned by the resemblance program vendor, and then, later, may be changed by the system administrator.

The results of the resemblance engine's processing are passed to output engine 140, which generates a vector r of the weighted resemblance values for the K closest sample software applications. Comparison engine 150 then compares the resemblance values rᵢ in vector r to a threshold value to determine if the resemblance values are high enough to use for identifying a discovered software application. The comparison engine 150 may receive an adjustable threshold value set through use of threshold engine 160. The value applied through threshold engine 160 may be set explicitly by a human user (e.g., resemblance value greater than 75 percent) with user input 170.

Each discovered software application, and each sample software application, may include a number of individual files, and corresponding attributes. For example, a discovered software application may be represented by file set P. File set P may contain fᵢ₌₁₋ₙ files, where each file fᵢ contains N attributes fᵢ={f₁ᵢ . . . fᵢₙ}, with fᵢⱼ representing file size, file name, or file signature.

The resemblance computation engine 130 computes a measure of the distance r between two files q and s using, for example, equation 1:

$$r ( q , s ) = {\sum }_{i = 1}^{N} • {k}_{i} \vert {q}_{i} - {s}_{i} \vert , \\ where \\ {\sum }_{i = 1}^{N} • {k}_{i} = 1 , \qquad ( 1 )$$

and
kᵢ is a weight value for each attribute N.

The value range of r(q, s) is 0.1.

To calculate the resemblance R(Q, S) between reference file set S={sᵢ|1≦l≦n, sᵢ≦sᵢ₊₁} and target file set Q={qᵢ|1≦l≦m, qᵢ≦qᵢ₊₂}, the resemblance computation engine 130 uses, for example, equation 2:

$$R ( Q , S ) = {\sum }_{i = 1}^{i = M} 〚 r ( \begin{matrix}{q}_{i} , & {s}_{j}\end{matrix} 〛 ) \qquad ( 2 )$$

where, q [symbol] Q, s [symbol] S, sⱼ₋ₗ<qᵢ<sⱼ

The output engine 140 then stores the output resemblance values, R(Q,S) of the K nearest neighbors to the target file set Q in vector R={R₁, R₂, . . . R_{K}}.

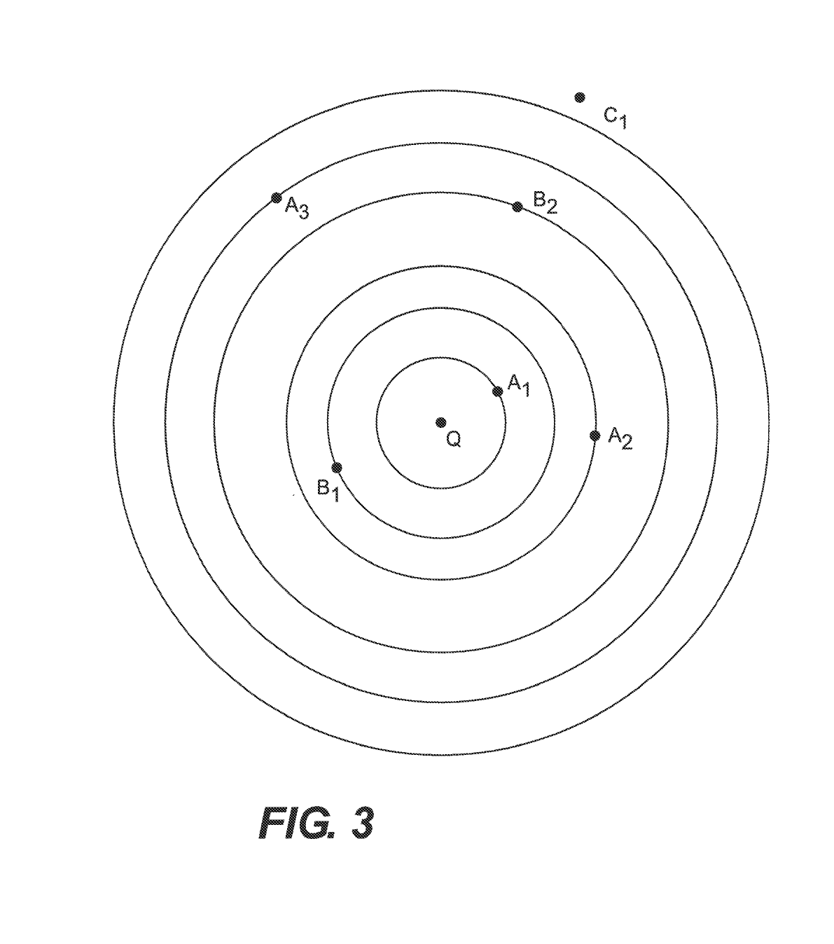

FIG. 3 illustrates a conceptual framework for the software recognition system of FIG. 2. In FIG. 3, target file set Q is shown at a center of concentric circles. Each circle represents one or more sample file sets Sᵢ, and those sample file sets' distance from the target file set Q. The closer a specific circle is to the center, the greater the resemblance value of the associated sample file set to the target file set. The framework may show all possible file sets. The computed distance (resemblance value) of a specific sample file set to the target file set is used to determine an identity of discovered software application to a sample software application. That is, provided a threshold value is reached, the sample software application with the highest resemblance value (i.e., the resemblance value closest to I/O) is should be the same software application as the discovered software application. Thus, in FIG. 3, sample software applications A₁, B₁, and A₂ all may exceed a predetermined threshold value, but sample software application A₁ is closest to target software application Q, and therefore would be chosen as the sample software application by which the target software application Q is to be identified.

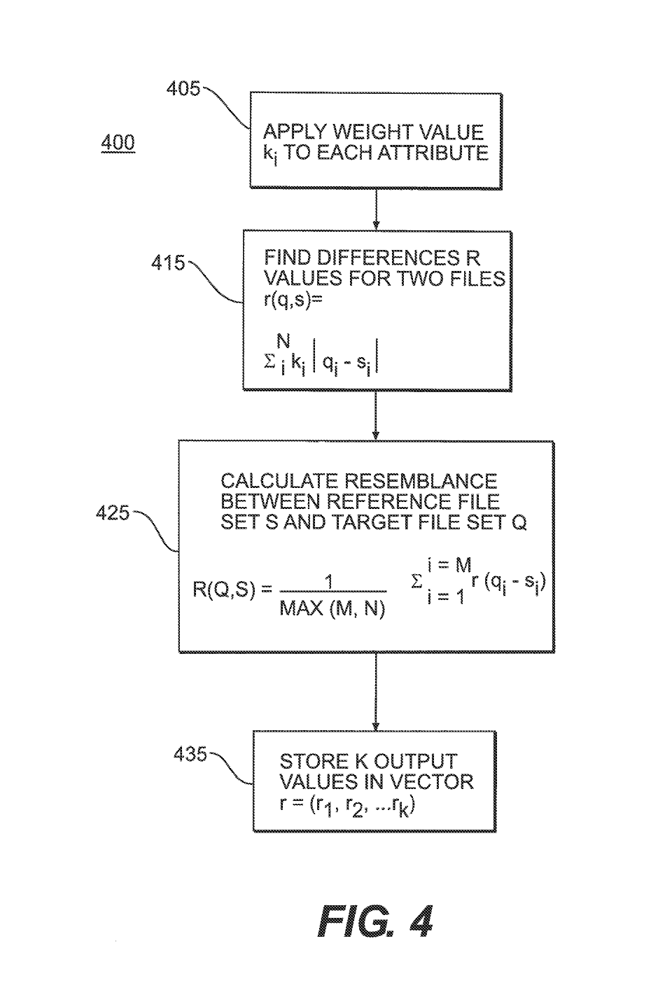

FIG. 4 illustrates an algorithm 400 used by the software recognition system of FIG. 2. In FIG. 4, processing blocks 405, 410, and 425 are executed by the resemblance computation engine 130 and processing bock 435 is executed by the output engine 140. In block 405, the engine 130 applies a weight to each of the files comprising the target software application file set and, if not already applied, to the file sets for K sample software applications, where K is greater than or equal to one. In one embodiment, weights may already be assigned to each of the files in the K sample software application file sets, and the engine 130 applies the same weights to each of the files in the target software application file set. For example, a main file in any file set may be a .exe file. This .exe file may be assigned a weight of 0.5. In this example, the corresponding .exe file from the target software application file set also would be assigned a weight of 0.5.

In block 415, the engine 130 finds the difference in attribute values for each file of file pair qᵢ, sᵢ. In block 425, the engine 130 calculates the resemblance R(Q,S) between the target software application file set and each of K sample software application file sets.

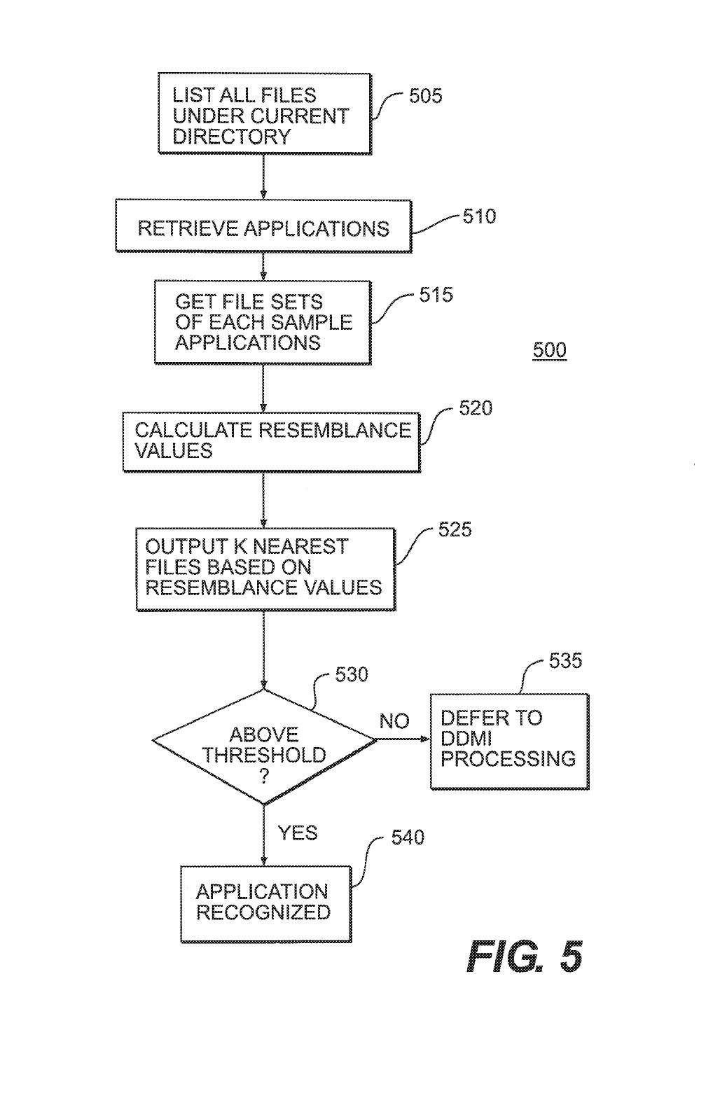

FIG. 5 illustrates an example of a method for software recognition using the software recognition system of FIG. 2. In FIG. 5, software recognition operation 500 begins in block 505 with a command to list all files under a current directory (i.e., a search of an existing computer network or network node is conducted to discover existing applications of a particular type). In block 510, all possible applications in a particular sample library are retrieved. In block 515, the resemblance engine 130 receives file sets of each sample application. In block 520, the resemblance engine calculates resemblance values between target file sets and sample file sets. Note that this step may involve as many iterations as there are combinations of sample file sets and individual target files. In block 525, the output engine 140 generates an output file of the K nearest resemblance values. In block 530, the comparison engine 150 determines if any resemblance values are above a predetermined threshold. If yes, the sample software application with the highest resemblance value above the threshold is recognized as the identity of the target software application, block 540. If not, the operation 500, returns to block 505, and DDMI recognition processing is executed.

The process of FIG. 5 can be seen with respect to the following tables 1-3. Table 1 illustrates a sample file data set. The first column of Table 1 lists a specific application. The applications are listed by vendor, name, release, and version. Other means for identifying a sample application are possible. The second column, file set, lists three parameters applicable to the column 1 application, namely, file name, size, and signature. Of course, additional or other parameters could be used.

TABLE 1
Sample Application Dataset

| Application | File Set | | |
|---|---|---|---|
| (publisher:name:release:version) | name | size | signature |
| Vendor1:app1:1:1.0 | file.dll | 1000 | 0F24-6106 |
| | file2.dll | 1500 | 0F34-6107 |
| | file3.dll | 45000 | 0F54-6108 |
| | file4.dll | 1500 | 0F64-6109 |
| Vendor1:app1:2:2.0 | file1.dll | 1000 | 0F24-6106 |
| | file2.dll | 1500 | 0F34-6107 |
| | file3.dll | 45000 | 0F54-6108 |
| | file4.dll | 1500 | 0F64-6109 |
| | file5.dll | 2500 | 0F64-6109 |
| | file6.dll | 3500 | 0F354-6118 |
| Vendor2:app2:1:1.2 | file1.dll | 1000 | 024-6106 |
| | file22.dll | 1500 | 0F34-6107 |
| | file33.dll | 3000 | 0F54-6108 |

Table 2 lists parameters of a target file set, with appropriate weights assigned to each of the three parameters.

TABLE 2
Target File Set Parameters

| Name (0.5) | Size (0.3) | Signature (0.2) |
|---|---|---|
| file1.dll | 1000 | 0F24-6106 |
| file3.dll | 45000 | 0F54-6108 |
| file55.dll | 25000 | 0F54-6118 |
| file2.dll | 1500 | 0F34-6107 |

Table 3 lists the resemblance values for the three (K=3) possible applications, along with the vector R(Q,S). Note that if the threshold value for resemblance is greater than or equal to 0.75, then the application vendor1:app 1:1:1.0 will be chosen. As noted above, this resemblance value calculation will proceed for each of the identified target sets.

TABLE 3
Resemblance Values for K = 3 Sample Applications

| Sample Application | R(Q, S) | Resemblance Value |
|---|---|---|
| Vendor1:app1:1:1.0 | (1 + 1 + 1 + 0)/4 | 0.75 |
| Vendor1:app1:2:2.0 | (1 + 1 + 1 + 0 + 0 = 0)/6 | 0.5 |
| Vendor2:app2:1:1.2 | 1 + 0.5 + 0.2 + 0)/4 | 0.375 |

What is claimed is:

1. A method for recognizing software applications installed on hardware devices, comprising:
scanning a hardware device to discover a target software application installed on the hardware device, wherein the target application comprises one or more files;
retrieving one or more sample applications for comparison to the target application;
determining a resemblance between the target application and each of the one or more sample applications; and
identifying the target application based on the resemblance determination.

2. The method of claim 1, wherein the target application and each of the one or more sample applications comprise one or more files, and wherein the resemblance determination is based on a distance between corresponding files of the target application and each of the one or more sample applications.

3. The method of claim 2, wherein each of the files comprises one or more attributes, further comprising:
applying a weight to each of the one or more attributes;
summing the weights; and
selecting a sample application with the highest summed weights for identifying the target application.

4. The method of claim 2, wherein for target application files qᵢ and sample application files sᵢ, the distance is measured as
$$r ( q , s ) = {\sum }_{i = 1}^{N} • {k}_{i} \vert {q}_{i} - {s}_{i} \vert ,$$
wherein
$${\sum }_{i = 1}^{N} • {k}_{i} = 1 ,$$
and wherein kᵢ is a weight value for each attribute N.

5. The method of claim 4, wherein to calculate the resemblance R(Q,S) between reference file set S={sᵢ|1≦l≦n, sᵢ≦sᵢ₊₁} and target file set Q={qᵢ|1≦l≦m, qᵢ≦qᵢ₊₁}, the resemblance computation is
$$R ( Q , S ) = {\sum }_{i = 1}^{i = M} 〚 r ( \begin{matrix}{q}_{i} , & {s}_{j}\end{matrix} 〛 ) ,$$
where, qᵢ [symbol] Q, sⱼ [symbol] S, sⱼ₋ₗ<qᵢ<sⱼ.

6. The method of claim 5, further comprising storing the output values, R(Q,S) of the K nearest sample file sets to the target file set Q in vector R={R₁, R₂, . . . R_{K}}.

7. The method of claim 6, further comprising applying a threshold to the K nearest sample file sets.

8. The method of claim 7, wherein no sample file set exceeds the threshold, further comprising using an alternate criteria for identifying the target software application.

9. The method of claim 1, further comprising:
determining a type of application for the target software application; and
selecting only those sample software applications that correspond to the determined type of application.

10. The method of claim 1, wherein the files include a .exe file, and wherein the .exe file is assigned a highest weight.

11. The method of claim 1, where a sum of the weights equals 1.0

12. A computer-readable medium including programming code for execution by a processor, the programming, when executed by the processor, implementing a method, comprising:
scanning a hardware device to discover a target software application installed on the hardware device, wherein the target application comprises one or more files;
retrieving one or more sample applications for comparison to the target application;
determining a resemblance between the target application and each of the one or more sample applications; and
identifying the target application based on the resemblance determination.

13. The computer-readable medium of claim 12, wherein the target application and each of the one or more sample applications comprise one or more files, and wherein the resemblance determination is based on a distance between corresponding files of the target application and each of the one or more sample applications.

14. The computer-readable medium of claim 13, wherein each of the files comprises one or more attributes, further comprising:
applying a weight to each of the one or more attributes;
summing the weights; and
selecting a sample application with the highest summed weights for identifying the target application.

15. The computer-readable medium of claim 13, wherein for target application files qᵢ and sample application files sᵢ, the distance is measured as
$$r ( q , s ) = {\sum }_{i = 1}^{N} • {k}_{i} \vert {q}_{i} - {s}_{i} \vert ,$$
wherein
$${\sum }_{i = 1}^{N} • {k}_{i} = 1 ,$$
and wherein kᵢ is a weight value for each attribute N.

16. The computer-readable medium of claim 15, wherein to calculate the resemblance R(Q,S) between reference file set S={sᵢ|1≦l≦n, sᵢ≦sᵢ₊₁} and target file set Q={qᵢ|1≦l≦m, qᵢ≦qᵢ₊₁}, the resemblance computation is R(Q,
$$S ) = {\sum }_{i = 1}^{i = M} 〚 r ( \begin{matrix}{q}_{i} , & {s}_{j}\end{matrix} 〛 ) ,$$
where, qᵢ [symbol] Q, sⱼ [symbol] S, sⱼ₋ₗ<qᵢ<sⱼ.

17. The computer-readable medium of claim 16, further comprising storing the output values, R(Q,S) of the K nearest sample file sets to the target file set Q in vector R={R₁, R₂, . . . R_{K}}.

18. The computer-readable medium of claim 17, further comprising applying a threshold to the K nearest sample file sets.

19. A system for recognizing a target software application, comprising:
a scanning engine that scans a hardware device to discover a target software application installed on the hardware device, wherein the target application comprises one or more files
a file retrieval engine that retrieves one or more sample applications for comparison to the target application;
a resemblance engine that determines a resemblance between the target application and each of the one or more sample applications; and
a comparison engine that identifies the target application based on the resemblance determination.

20. The system of claim 19, wherein the resemblance engine applies a weight to each of the one or more attributes, sums the weights, and selects a sample application with the highest summed weights for identifying the target application further comprising, and wherein the resemblance engine calculates the resemblance R(Q,S) between reference the set S={sᵢ|1≦l≦n, sᵢ≦sᵢ₊₁} and target the set Q={(qᵢ|1≦l≦m, qᵢ≦qᵢ₊₁}, as is
$$R ( Q , S ) = {\sum }_{i = 1}^{i = M} 〚 r ( \begin{matrix}{q}_{i} , & {s}_{j}\end{matrix} 〛 ) ,$$
where, qᵢ [symbol] Q, sⱼ [symbol] S, sⱼ₋ₗ<qᵢ<sⱼ, and wherein for target application files qᵢ and sample application files sᵢ, the resemblance engine computes a distance as
$$r ( q , s ) = {\sum }_{i = 1}^{N} • {k}_{i} \vert {q}_{i} - {s}_{i} \vert ,$$
wherein
$${\sum }_{i = 1}^{N} • {k}_{i} = 1 ,$$
and wherein kᵢ is a weight value for each attribute N.
